(19) United States
(12) Patent Application Publication
(10) Pub. No.: US 2026/0303928 A1
(43) Pub. Date: Oct. 1, 2026

(54) METHODS AND SYSTEMS FOR PROVIDING TARGETED CONTENT

(71) Applicant: Comcast Cable Communications, LLC, Philadelphia, PA (US)

(72) Inventors: Robert Gaydos, Philadelphia, PA (US); Elad Nafshi, Philadelphia, PA (US); Mustafa Onder, Philadelphia, PA (US); Mehul Patel, Philadelphia, PA (US)

(21) Appl. No.: 19/095,960

(22) Filed: Mar. 31, 2025

(51) Int. Cl. H04N 21/81; H04N 21/234; H04N 21/258; H04N 21/431

(52) U.S. Cl. CPC H04N 21/812; H04N 21/23424; H04N 21/25891; H04N 21/4318

(57) ABSTRACT

Methods, apparatuses, and systems are described for providing targeted content. A computing device such as a termination system may monitor network traffic data between a user device and a content server in order to determine requests for targeted content such as advertisements. The computing device may intercept the requests, and reroute the requests to an alternate content server, e.g., based on user data available to the computing device. Targeted content may be received from the alternate content server by the computing device, and transmitted to the user device.

### BACKGROUND

Content delivery systems have become increasingly sophisticated, aiming to provide users with more relevant and personalized content. These systems often rely on user data and preferences to tailor content, particularly in the realm of targeted advertising. However, many existing content delivery systems face challenges in effectively customizing content in real-time while maintaining user privacy and system efficiency. Traditional targeted advertising methods typically involve collecting and analyzing user data over time to build user profiles. While this approach can provide some level of personalization, it may not always capture a user's current context or immediate interests. Additionally, the storage and management of extensive user profiles raise privacy concerns and is resource-intensive for content providers.

In the context of video streaming and other content delivery platforms, the insertion of targeted content, such as advertisements, presents additional technical challenges. These platforms often use content delivery networks (CDNs) and complex manifest files to manage the streaming process. Modifying content streams in real-time to insert personalized content segments is technically demanding and impacts the user experience if not implemented efficiently. There is a growing need for content delivery systems that can provide highly targeted and personalized content while respecting user privacy, operating efficiently at scale, and seamlessly integrating with existing content delivery infrastructure. Improved methods for determining relevant content based on real-time user context and inserting this content into ongoing content streams could enhance the effectiveness of targeted advertising and other personalized content delivery applications.

### SUMMARY

It is to be understood that both the following general description and the following detailed description are examples and explanatory only and are not restrictive. Methods, systems, and apparatuses for providing targeted content are disclosed.

A computing device, such as a termination system, may perform analysis and routing to provide targeted content to a user device. The computing device may monitor network traffic, such as content streams, between the user device and a content server, and intercept requests, intended for an advertisement server, for a content segment to be inserted into a content stream being received by the user device. The computing device may reroute the request to a different content server. The different content server may provide a different, more targeted, content segment to the computing device, for insertion and transmission to the user device.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows an example system for providing targeted content;

FIGS. 2A-2B show an example scenario for providing targeted content;

FIG. 3 shows an example process for providing targeted content;

FIG. 4 shows an example process for generating targeted content;

FIGS. 5A-5B show examples of generated content;

FIG. 6 shows an example advertisement insertion process;

FIG. 7 shows a flowchart of an example method;

FIG. 8 shows a flowchart of an example method;

FIG. 9 shows a flowchart of an example method; and

FIG. 10 shows a block diagram of an example system and computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

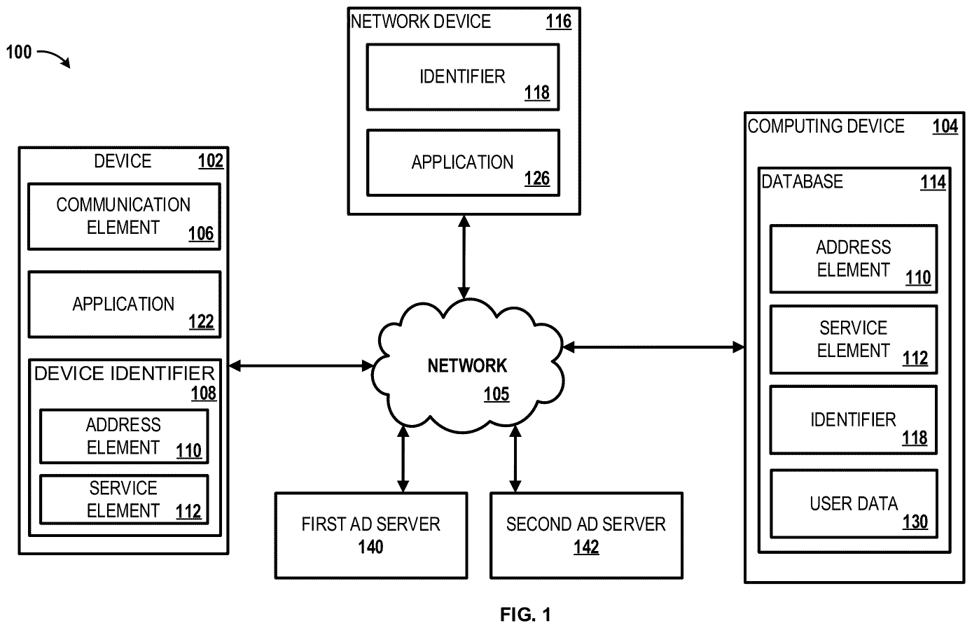

FIG. 1 shows an example system 100 for providing targeted content (e.g., advertisement content) to a user. In the context of video streaming and other content delivery platforms, the insertion of targeted content, such as advertisements, presents technical challenges. These platforms use CDNs and complex manifest files to manage the streaming process. Modifying content streams in real-time to insert personalized content segments is technically demanding and impacts the user experience if not implemented efficiently. By way of example, the present methods and systems address these challenges by providing a system and method for intercepting and rerouting content segment requests. This approach allows for the seamless insertion of customized content based on user data without significantly altering the existing content delivery infrastructure. By leveraging real-time request interception, the methods and systems enable more accurate targeting based on current user context while reducing reliance on long-term user profiles. Additionally, the system offers improved privacy protection by processing user data closer to the edge of the network, minimizing the need for centralized storage of sensitive information.

As an example, a computing device (e.g., a termination system) may intercept a request for a content segment (e.g., advertisement content segment), for insertion into a content stream being accessed (e.g., output) by a user device, from the user device, wherein the request is sent by the user device to a first advertisement server. The computing device may reroute the request to a second advertisement server, wherein the second advertisement server may send a content segment associated with user data associated with an identifier of the user device to the user device. The user device may insert the content segment into the content stream for output to the user. The system 100 may comprise a device 102, a network device 116, a computing device 104, a first advertisement server 140, and/or a second advertisement server 142. The device 102 and/or the network device 116 may be in communication with the computing device 104 such as a centralized device or a server, for example. The computing device 104 may be disposed remotely relative to the device 102, the network device 116, the first advertisement server 140, and the second advertisement server 142. As an example, the device 102, the network device 116, the first advertisement server 140, the second advertisement server 142, and the computing device 104 may be in communication via a private and/or public network 105 such as the Internet or a local area network. Other forms of communications can be used such as wired and wireless telecommunication channels.

The device 102 may comprise electronic devices such as a computer, a smartphone, a laptop, a tablet, a set top box, a display device, a printer, a network device, a communication terminal, or other device capable of communicating with the network device 116 and the computing device 104. As an example, the device 102 may comprise a communication element 106 for offering an interface to a user to interact with the device 102, the network device 116, and/or the computing device 104. The communication element 106 may be any interface for presenting and/or receiving information to/from the user, such as media content. As an example, the interface may be a communication interface such as a web browser (e.g., Internet Explorer®, Mozilla Firefox®, Google Chrome®, Safari®, or the like). Other software, hardware, and/or interfaces can be used to facilitate communication between the user and one or more of the device 102 and the network device 116. As an example, the communication element 106 can request or query various files from a local source and/or a remote source. As an example, the communication element 106 can transmit data to a local or remote device such as the network device 116 or the computing device 104 via the network device 116.

The device 102 may be associated with a user identifier or a device identifier 108. As an example, the device identifier 108 may be any identifier, token, character, string, or the like, for differentiating one user or user device (e.g., device 102) from another user or user device. The device identifier 108 may identify a user or user device as belonging to a particular class of users or user devices. As an example, the device identifier 108 may comprise information relating to the user device such as a manufacturer, a model or type of device, a service provider associated with the device 102, a state of the device 102, a locator, and/or a label or classifier. Other information can be represented by the device identifiers 108.

The device identifier 108 may comprise address element 110 and service element 112. The address element 110 may comprise or make available an internet protocol address, a network address, a media access control (MAC) address, an Internet address, or the like. As an example, the address element 110 may be relied upon to establish a communication session between the device 102 and the network device 116 or other devices and/or networks. As an example, the address element 110 may be used as an identifier or locator of the device 102. The address element 110 may be persistent for a particular network.

The service element 112 may comprise identification of the service providers associated with the device 102 and/or with the class of device 102. The class of the device 102 may be related to a type of device, a capability of a device, a type of service being offered, and/or a level of service (e.g., a business class, a service tier, a service package, etc.). As an example, the service element 112 may comprise information relating to or made available by a communication service provider (e.g., an Internet service provider) that is offering or enabling data flow such as communication services to the device 102. As an example, the service element 112 may comprise information relating to a preferred service provider for one or more particular services relating to the device 102. The address element 110 may be used to identify or retrieve data from the service element 112, or vice-versa. As an example, one or more of the address element 110 and the service element 112 may be stored remotely from the device 102 and retrieved by one or more devices such as the device 102 and the computing device 104. Other information may be represented by the service element 112.

The network device 116 may be in communication with a network, such as network 105. As an example, the network device 116 may be configured as a set top box. As an example, one or more of the network devices 116 may be configured to facilitate the connection of a device, such as the device 102, to the network 105. As an example, the network device 116 may be configured as a wireless access points (WAPs) or router. The network device 116 may be configured to allow one or more wireless devices to connect to a wired and/or wireless network using Wi-Fi, Bluetooth®, Zigbee®, or any desired method or standard.

The network device 116 may be configured as a local area network (LAN). As an example, the network device 116 may comprise a dual band wireless access point. As an example, the network device 116 may be configured with a first service set identifier (SSID) (e.g., associated with a user network or a private network) to function as a local network for a particular user or users. As an example, the network device 116 may be configured with a second service set identifier (SSID) (e.g., associated with a public/community network or a hidden network) to function as a secondary network or redundant network for connected communication devices.

The network device 116 may comprise identifier 118. As an example, one or more identifiers may be or relate to an Internet Protocol (IP) Address IPV4/IPV6 or a media access control address (MAC address) or the like. As an example, the identifier 118 may be unique identifiers for facilitating communications on the physical network segment. The network device 116 may comprise an identifier 118 that is distinct. As an example, the identifier 118 may be associated with a physical location of the network device 116.

The device 102 and/or the network device 116 may include applications 122, 126, respectively, which may be partially or fully executed in a device environment of the device 102 and/or the network device 116. The applications 122, 126 may be configured to cause the device 102 and/or the network device 116 to request a content stream for output at the device 102 and/or the network device 116. In an example, the content stream may be associated with data (e.g., metadata, manifests, etc.) for requesting content segments (e.g., advertisement content) to be inserted into the content stream. Based on the data associated with the content stream, the applications 122, 126 may cause the device 102 and/or the network device 116 to send a request to an initial advertisement server (e.g., first advertisement server 140) for a content segment (e.g., advertisement content) to be inserted into the content stream. For example, the request for the content segment may comprise a domain name system (DNS) request associated with a URL associated with a manifest, or metadata, for retrieving an advertisement content segment. A computing device (e.g., computing device 104, a cable modem termination system (CMTS) device, a virtual CMTS (vCMTS), or a virtual broadband network gateway (vBNG), etc.) may intercept the request and reroute the request to a second advertisement server (e.g., second advertisement server 142). The device 102 and/or the network device 116 may receive a content segment from the second advertisement server, via the computing device, and insert the content segment into the content stream for output at the device 102 and/or the network device 116. For example, the second advertisement server may determine the content segment based on identifier information (e.g., identifier 108, 118, address element 110, and/or service element 112) associated with the device 102 and/or the network device 116. For example, the computing device may determine the identifier information associated with the device 102 and/or the network device 116 based on monitoring the data associated with the content stream. For example, the computing device may identify the identifier information based on data of the request for the content stream, network traffic data associated with the content stream, and/or the request for the content segment. For example, the computing device may identify the identifier information based on a dynamic host configuration protocol (DHCP) request from the device 102 and/or the network device 116. For example, the device 102 and/or the network device 116 may send the DHCP request for requesting an IP address, wherein the device 102 and/or the network device 116 may include a MAC address associated with the device 102 and/or the network device 116 in the DHCP request. The computing device may determine the identifier information based on the MAC address associated with the device 102 and/or the network device 116. The computing device may forward the identifier information to the second advertisement server, wherein the second advertisement server may determine the content segment based on the identifier information and send the content segment to the device 102 and/or the network device 116. The applications 122, 126 may cause the device 102 and/or the network device 116 to then insert the content segment into the content stream for output at the device 102 and/or the network device 116. In an example, the computing device and/or the second advertisement server may be configured to generate the content segment based on the identifier information. In an example, the applications 122, 126 may cause the device 102 and/or the network device 116 to splice the content segment into the content stream at a time point associated with the request for a content segment. For example, the content stream may be associated with one or more time points/intervals (e.g., based on a manifest, metadata, etc.) for inserting one or more content segments into the content stream. The applications 122, 126 may cause the device 102 and/or the network device 116 to send a request for a content segment at each time point associated with the content stream and receive a content segment based on each request. In an example, the computing device and/or the second advertisement server may insert/splice the content segment into the content stream for output at the device 102 and/or the network device 116.

The computing device 104 may be a server, or a centralized device, for communicating with the network device 116, the device 102, the first advertisement server 140, the second advertisement server 142, and the like within the network 105. In an example, the computing device 104 may communicate with the device 102 for offering data and/or services. For example, the computing device 104 may offer services such as network (e.g., Internet) connectivity, network printing, media management (e.g., a media server), interference management, content services, streaming services, broadband services, or other network-related services.

The computing device 104 may allow the device 102 and/or the network device 116 to interact with remote resources such as data, devices, and files. As an example, the computing device 104 may be configured as (or disposed at) a central location (e.g., a headend, or a processing facility), which can receive content (e.g., data, input programming) from multiple sources. In an example, the computing device 104 may be a separate/remote device from the server for determining malicious activity within the communication network (e.g., network 105). The computing device 104 can combine the content from the multiple sources and can distribute the content to user (e.g., subscriber) locations via a distribution system.

The computing device 104 may be configured to manage the communication between the device 102 and the network device 116 and a database 114 (e.g., storage system) for sending and receiving data therebetween. As an example, the database 114 may be configured to store a plurality of files, user identifiers or records, or other information. As an example, the device 102 and/or the network device 116 may request and/or retrieve one or more files from the database 114. The database 114 may store information relating to the device 102 such as the address element 110 and/or the service element 112. As an example, the computing device 104 may obtain the device identifier 108 and/or 118 from the device 102 and/or the network device 116 and retrieve information from the database 114 such as the address element 110 and/or the service element 112. As a further example, the computing device 104 may obtain the address element 110 from the device 102 and/or the network device 116 and may retrieve the service element 112 from the database 114, or vice versa. The database 114 may be integrated with the computing device 104 or some other device or system.

The computing device 104 may be maintained and/or managed by a content and/or a media service provider, such as a cable television (CATV) provider or an Internet service provider (ISP). The computing device 104 may include any reasonably suitable electrical equipment for receiving, storing, and/or re-transmitting content/media signals, such as content/media servers, satellite receivers, modulators/demodulators, edge decoders, and/or the like. For example, the computing device 104 may comprise a boundary point between networks, such as a termination system. For example, the computing device 104 may comprise a CMTS, a vCMTS, a vBNG, and the like. For example, the computing device 104 may be configured as an intermediary between one or more user devices (e.g., the device 102, the network device 116, etc.) and a backbone network/portion (e.g. the Internet) of the network 105. The computing device 104 may forward/send data received from a backbone network to the user devices and forward data received from the user devices onto the backbone network. The computing device 104 may comprise an optical transmitter and an optical receiver for transmitting and/or receiving messages from the user devices. The computing device 104 may include transmitters and/or receivers for communicating with the backbone network. The computing device 104 may include a converter that may convert any protocol used within the backbone network to a protocol suitable for data communication with the user devices. For example, the computing device 104 may send/transmit signals (e.g., media signals, broadband signals, content signals, etc.) downstream to the user devices via a fiber-optic connection/communication link to a fiber optic node supporting the user devices. The fiber optic node may, for example, receive and convert optical signals sent from the computing device 104 to RF signals that are sent to the user devices via distributed taps (e.g., subscriber taps, etc.) distributed via coaxial cables to the user devices.

The computing device 104 may be configured to intercept requests for content segments from a user device (e.g., the device 102, the network device 116, etc.) intended for a first advertisement server 140. For example, the user device may request a content stream for output at the user device. For example, the user device may send the request for the content stream to a source of the content stream. The computing device 104 may monitor network traffic data between the user device and the source of the content stream (e.g., network traffic data associated with the content stream). For example, the computing device 104 may perform a deep packet inspection of the network traffic data associated with the content stream to determine when a user device sends a request for a content segment (e.g., advertisement content) for insertion into the content stream. The computing device 104 may reroute the request to a second advertisement server 142. The second advertisement server 142 may determine a content segment to be sent to the user device based on identifier information (e.g., identifier 108, 118, address element 110, and/or service element 112) associated with the user device. For example, the computing device 104 may determine the identifier information associated with the user device based on monitoring the network traffic between the user device and the source of the content stream (e.g., data associated with the content stream). For example, the computing device 104 may identify the identifier information based on data of the request for the content stream, the network traffic data associated with the content stream, and/or the request for the content segment. For example, the computing device 104 may identify the identifier information based on a DHCP request from the user device. For example, the user device may send the DHCP request for requesting an IP address, wherein the user device may include a MAC address associated with the user device in the DHCP request. The computing device 104 may determine the identifier information based on the MAC address associated with the user device. The computing device 104 may forward the identifier information to the second advertisement server 142, wherein the second advertisement server 142 may determine the content segment based on the identifier information. As an example, the computing device 104 and/or the second advertisement server 142 may determine user data 130 associated with the identifier information. The user data 130 may comprise one or more of demographic information, personal information, user preference information, and/or language preference information. The second advertisement server 142 may determine the content segment based on the user data 130. In an example, the computing device 104 may store the user data 130 in the database 114. In an example, the computing device 104 may associate the user data 130 with associated identifier information in the database 114. The computing device 104 may determine the user data 130 based on matching the identifier information determined from monitoring the network traffic data with the identifier information associated with the user data 130 in the database 114. The second advertisement server 142 may send the content segment to the computing device 104, wherein the computing device 104 may insert the content segment into the content stream for output at the user device. For example, the computing device 104 may splice the content segment into the content stream at a time point associated with the request for a content segment. For example, the content stream may be associated with one or more time points/intervals (e.g., based on a manifest, metadata, etc.) for inserting one or more content segments into the content stream. The computing device 104 may receive a request for a content segment at each time point associated with the content stream and insert/splice the content segment into the content stream at each time point. In an example, the second advertisement server 142 may insert/splice the content segment into the content stream. In an example, the computing device 104 may send the content segment to the user device, wherein the user device may insert/splice the content segment into the content stream.

In an example, the computing device 104 and/or the second advertisement server 142 may be configured to generate the content segment. For example, the computing device 104 and/or the second advertisement server 142 may determine a base content segment of one or more base content segments. For example, the one or more base content segments may comprise one or more generic content segments that may be pre-generated and stored at the computing device 104 and/or the second advertisement server 142. Each base content segment may be stored with metadata associated with each corresponding content segment. The metadata may be associated with customization information (e.g., one or more attributes) associated with each corresponding base content segment. The computing device 104 and/or the second advertisement server 142 may determine the base content segment based on the content stream and the metadata associated with the one or more base content segments. For example, the computing device 104 and/or the second advertisement server 142 may determine the content stream being output by the user device based on the DNS request. For example, the computing device 104 and/or the second advertisement server 142 may determine that since an IP address (e.g., identifier information) associated with the user device is requesting the content stream, the user device must be accessing (e.g., outputting) the content stream. For example, the content stream may be associated with one or more time points/intervals for inserting one or more content segments into the content stream. Each insertion time point may be pre-allocated for certain types of content to be inserted at each insertion time point. For example, the time points may be sold during an advertisement sales process. In an example, a first time point may be pre-allocated for an advertisement campaign associated with a car manufacture while a second time point may be pre-allocated for an advertisement campaign associated with a toy manufacture. The computing device 104 and/or the second advertisement server 142 may determine the base content segment based on the base content segment being associated with a type of content (e.g., a car advertisement) pre-allocated for the requested insertion time point. The computing device 104 and/or the second advertisement server 142 may generate a modified base content segment based on the identifier information associated with the user device and the base content segment. For example, the computing device 104 and/or the second advertisement server 142 may modify one or more attributes of the base content segment based on the identifier information in order to generate the modified base content segment. The one or more attributes may comprise one or more of an actor, an object, a language, or text. For example, the computing device 104 and/or the second advertisement server 142 may tailor the base content segment for targeting a user or the user device associated with the identifier information. For example, the computing device 104 and/or the second advertisement server 142 may tailor the one or more attributes based on one or more of the demographic information, personal information, or user preference information of the user determined based on the identifier information associated with the user data 130.

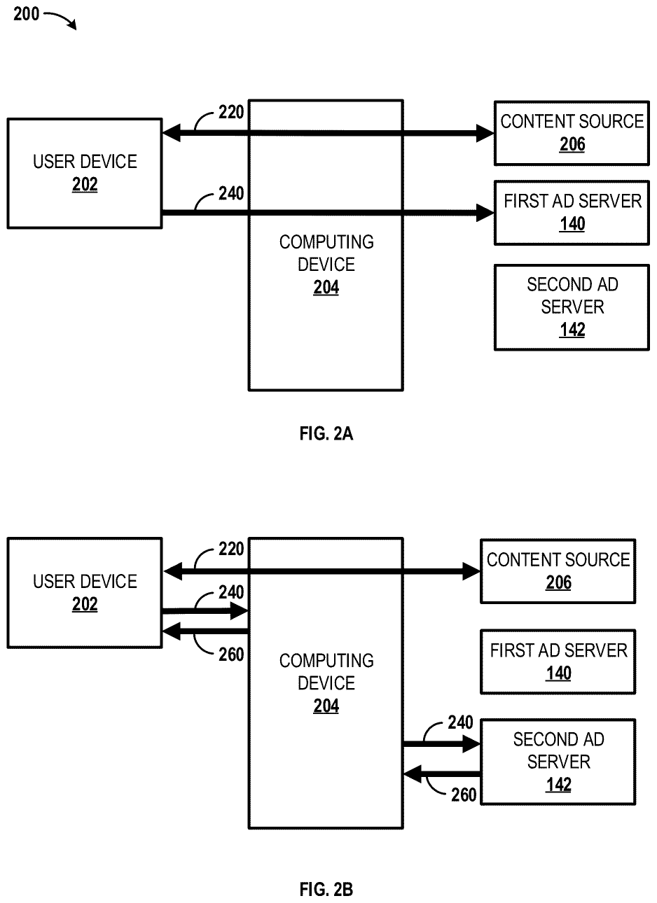

FIGS. 2A and 2B show an example scenario 200 for providing targeted content to a user device 202 (e.g., device 102, network device 116). As shown in FIG. 2A, a user device 202 may attempt to send a request 240 to a first advertisement server 140 for a content segment (e.g., advertisement content) for insertion into a content stream being output at the user device 202. For example, the user device 202 may send a request 240 for the content stream to a content source 206 of the content stream. A computing device 204 (e.g., computing device 104) may monitor the network traffic 220 between the content source 206 and the user device 202 associated with the content stream (e.g., data 220 associated with the content stream). For example, the computing device 204 may comprise a boundary point between networks, such as a termination system. For example, the termination system can be a fiber optic termination system, a wireless network termination system, a cable modem termination system (CMTS, or a vCMTS), or a virtual network broadband gateway (vBNG), etc. For example, the computing device 104 may be configured as an intermediary between one or more user devices 202 and a backbone network/portion (e.g. the Internet) of a network. The computing device 204 may perform a deep packet inspection of the data 220 associated with the content stream to determine when the user device 202 sends a request 240 for a content segment for insertion into the content stream. Based on monitoring the network traffic 220 between the content source 206 and the user device 202 associated with the content stream, the computing device 204 may determine and intercept a request 240 from the user device 202, intended for a first advertisement server 140, as shown in FIG. 2B. The computing device 204 may then reroute the request 240 to a second advertisement server 142. The second advertisement server 142 may determine a content segment to be sent to the user device 202 based on user data associated with the user device 202. For example, the computing device 204 may determine identifier information (e.g., identifier 108, 118, address element 110, and/or service element 112) associated with the user device 202 based on monitoring the network traffic 220 between the user device 202 and the content source 206 of the content stream (e.g., data associated with the content stream). For example, the computing device 104 may identify the identifier information based on data of the request for the content stream, network traffic data 220 associated with the content stream, and/or the request 240 for a content segment. For example, the computing device 204 may identify the identifier information based on a DHCP request from the user device 202. For example, the user device 202 may send the DHCP request for requesting an IP address, wherein the user device 202 may include a MAC address associated with the user device 202 in the DHCP request. The computing device 204 may determine the identifier information based on the MAC address associated with the user device 202. The computing device 204 may forward the identifier information to the second advertisement server 142, wherein the second advertisement server 142 may determine the content segment 260 based on the identifier information. As an example, the computing device 204 and/or the second advertisement server 142 may determine user data associated with the identifier information. The computing device 204 and/or the second advertisement server 142 may determine the content segment 260 based on the user data. The user data may comprise one or more of demographic information, personal information, user preference information, and/or language preference information based on the identifier information. The second advertisement server 142 may send the content segment 260 to the computing device 204, wherein the computing device 204 may forward the content segment 260 to the user device 204. The user device 204 may insert the content segment 260 into the content stream. In an example, the computing device 204 may insert the content segment 260 into the content stream. In an example, the user device 204 may insert the content segment 260 into the content stream.

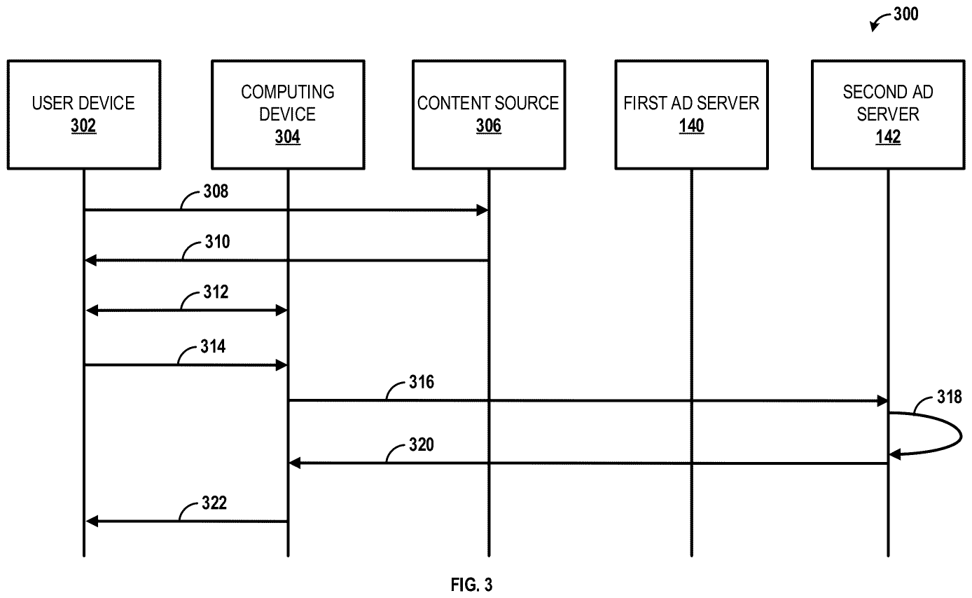

FIG. 3 shows an example process 300 for providing targeted content. At 308, the user device 302 (e.g., device 102, network device 116, etc.) may send a request to a content source 306 for a content stream for output at the user device 302, wherein the user device 302 may receive the content stream from the content source at 310. A computing device 304 (e.g., computing device 104, a termination system, etc.) may monitor network traffic between the user device 302 and the content source 306 (e.g., network traffic data associated with the content stream) at 312. For example, the computing device 104 may perform a deep packet inspection of the network traffic data associated with the content stream to determine when a user device 302 sends a request for a content segment for insertion into the content stream. For example, the content stream may be associated with data (e.g., metadata, manifests, etc.) for requesting advertisement content segments for insertion into the content stream. Based on the data associated with the content stream, the user device 302 may send a request to a first advertisement server 140 for a content segment (e.g., advertisement content) for insertion into the content stream. However, the computing device 304 may intercept the request for the content segment at 314, as shown in FIG. 3. At 316, the computing device 304 may send the request to the second advertisement server 142.

The second advertisement server 142 may determine a content segment to send to the user device 302 at 318. In an example, the second advertisement server 142 may determine the content segment based on identifier information associated with the user device 302. For example, the computing device 304 may determine the identifier information associated with the user device 302 based on monitoring the data associated with the content stream. For example, the computing device 304 may identify the identifier information based on data of the request for the content stream, network traffic data associated with the content stream, and/or the request for the content segment. For example, the computing device 304 may identify the identifier information based on a dynamic host configuration protocol (DHCP) request from the user device 302. For example, the user device 302 may send the DHCP request for requesting an IP address, wherein the user device 302 may include a MAC address associated with the user device 302 in the DHCP request. The computing device 304 may determine the identifier information based on the MAC address associated with the user device 302. The computing device 304 may forward the identifier information to the second advertisement server 142 with the request for a content segment, wherein the second advertisement server 142 may determine the content segment based on the identifier information. In an example, the second advertisement server 142 may determine the content segment based on user data associated with the user device 302. For example, the computing device 304 may determine user data associated with the user device 302 based on the identifier information and send the user data to the second advertisement server 142. The user data may comprise one or more of demographic information, personal information, user preference information, and/or language preference information. In an example, the second advertisement server 142 may determine the user data based on the identifier information.

At 320, the second advertisement server 142 may send the content segment to the computing device 304. At 322, the computing device 304 may send the content segment to the user device 302. The user device 302 may then insert the content segment into the content stream for output at the user device 302. For example, the user device 302 may splice the content segment into the content stream at a time point associated with the request for a content segment. For example, the content stream may be associated with one or more time points/intervals (e.g., based on a manifest, metadata, etc.) for inserting one or more content segments into the content stream. The user device 302 may send a request for a content segment at each time point associated with the content stream and receive a content segment based on each request. In an example, the second advertisement server 142 may insert/splice the content segment into the content stream for output at the user device 302. In another example, the computing device 304 may insert/splice the content segment into the content stream for output at the user device 302.

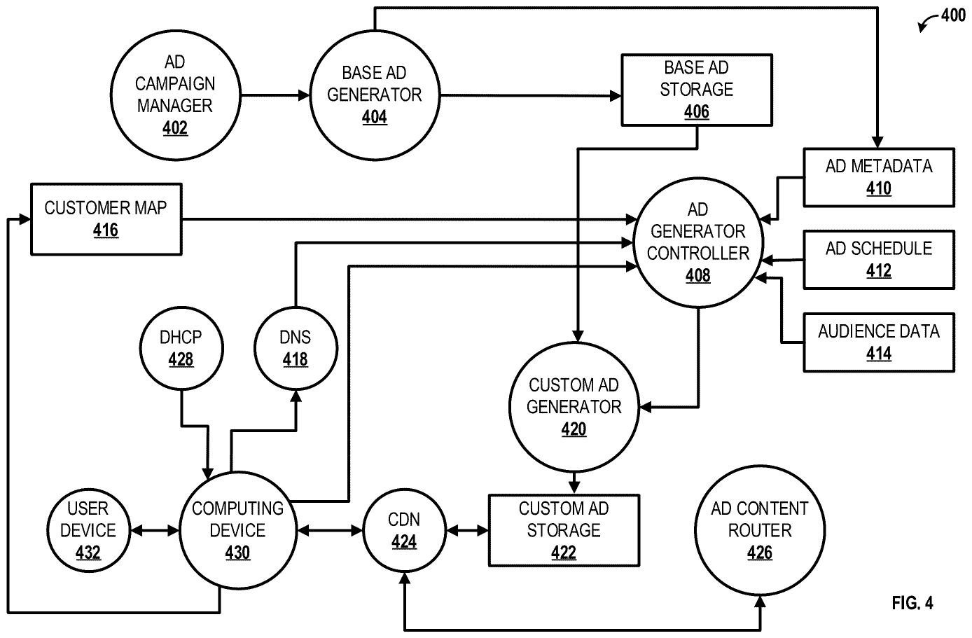

FIG. 4 shows an example process 400 for generating targeted content (e.g., at the computing device 104, the second advertisement server 142, etc.). When an advertisement campaign manager 402 generates an advertisement campaign, the advertisement campaign manager 402 may provide one or more attributes for different advertisements, and/or different types of advertisements to a base advertisement generator 404. For example, a car advertisement campaign may comprise one or more attributes associated with car models targeted towards one or more demographic areas (e.g., area of the country, age, race, etc.). The base advertisement generator 404 may generate base advertisements (e.g., content segments) with a generic actor(s) and/or generic products (e.g., “green screen” actors and/or products). In addition, the base advertisement generator 404 may generate metadata associated with each base advertisement and with the one or more attributes of each advertisement. The metadata may be used to indicate customization areas/points (e.g., the one or more attributes) in the original video/image of the advertisement that may be modified. The base advertisement generator 404 may generate a plurality of copies of the base advertisement and provide the plurality of copies of the base advertisement to a base advertisement storage 406 for storage at the base advertisement storage 406. In an example, the metadata may be stored in an advertisement metadata database 410 containing a list of customization information (e.g., the one or more attributes) associated with the advertisements and advertisement campaign parameters. During an advertisement sales process, advertisement slots (e.g., time points) in streaming content may be sold. For example, the advertisement slots may be based on time of day or for a specific content stream, application, content source, broadcast program, etc. For example, during the super bowl, a time point may be pre-allocated to an advertisement campaign of a car manufacturer.

The computing device 430 (e.g., computing device 104, a termination system, etc.) may determine a user and/or user device 432 (e.g., user device 102, network device 116, etc.) accessing a content stream. For example, the computing device 430 may be located at a border (e.g., edge) of a service provider's IP network. The computing device 430 may determine identifier information (e.g., identifier 108, 118, address element 110, and/or service element 112) associated with the user device 432 accessing the content stream. For example, the computing device 430 may determine the identifier information associated with the user device 432 based on monitoring the network traffic between the user device 432 and a source of the content stream (e.g., data associated with the content stream). For example, the computing device 430 may identify the identifier information based on data of a request by the user device 432 for the content stream, the network traffic data associated with the content stream, and/or a request by the user device 432 for advertisement content. For example, the computing device 104 may identify the identifier information based on a DHCP request from the user device 432. For example, the user device 432 may send the DHCP request to a DHCP server 428 for requesting an IP address, wherein the user device 432 may include a MAC address associated with the user device 432 in the DHCP request. The computing device 430 may determine the identifier information based on the MAC address associated with the user device 432. The computing device 430 may send the identifier information and a customer ID (e.g., user device 423 MAC) to a customer map database 416, wherein the identifier information may be associated with the customer ID.

The computing device 430 may also determine the content stream being accessed by the user device 432. For example, the user device 432 may send a DNS request for the content stream. In an example, the user device 432 may also send a DNS request for advertisement content for insertion into the content stream. The computing device 430 may determine (e.g., identify) and intercept the DNS requests (e.g., for any content segment) from the user device 432 based on monitoring network traffic data associated with the user device 432. As an example, the computing device 430 may force all network traffic data to go through the computing device 430 before reaching the intended destination(s). In an example, if the DNS request is encrypted, the computing device 430 may intercept the DNS request at a DNS server 418.

The advertisement generator controller 408 may control the custom advertisement generator 420 to generate advertisement content (e.g., a content segment) based on a user device 432 DNS request for advertisement content for insertion into the content stream. The advertisement generator controller 408 may cause the custom advertisement generator 420 to generate advertisement content based on data from one or more inputs such as the advertisement metadata database 410, an advertisement schedule database 412, an audience database 414 that includes general audience demographic data, the customer map database 416, the DNS server 418, and/or the computing device 430. In an example, the computing device 430 may forward the DNS request for advertisement content for insertion into the content stream from the user device 432 to the advertisement generator controller 408. In an example, if the computing device 430 cannot access the DNS request or the identifier information associated with the user device 432, the computing device 430 may intercept the DNS request at the DNS server 418 and cause the DNS server 418 to look up the IP address accessing the content stream and send the IP address to the advertisement generator controller 408. The advertisement generator controller 408 may then determine the identifier information based on matching the IP address with an IP address from the customer map database 416 associated with the identifier information. The advertisement generator controller 408 may access the advertisement metadata in the advertisement metadata database 410, the advertisement schedule information in the advertisement schedule database 412, and the audience demographic data in the audience database 414 to determine which base advertisement content (e.g., content segment) in the base advertisement storage 406 to use for generating custom advertisement content for insertion into the content stream based on the identifier information associated with the user device 432. For example, the advertisement generator controller 408 may extract demographic information (e.g., user data) associated with the user and/or the user device 432 from the audience database 414 when it receives the identifier information and the content stream with an advertisement time point for inserting advertisement content. In addition, the advertisement generator controller 408 may determine a location of the user device 432 and determine a custom advertisement generator 420 of a plurality of custom advertisement generators 420 best suited for generating the requested advertisement content. For example, each customer advertisement generator 420 may be located in a different area, wherein the customer advertisement generator 420 located closest to the requesting user device 430 may be identified and used for generating the advertisement content. The advertisement generator controller 408 may then cause the advertisement generator 420 to generate advertisement content (e.g., content segment) based on the demographic information. The advertisement generator 420 may send the generated advertisement content to the custom advertisement storage 422 for storage at the custom advertisement storage 422.

The computing device 430 may access the generated advertisement content, via a content delivery network (CDN) 424, from the custom advertisement storage 422, and send the generated advertisement content to the user device 432. For example, the computing device 430 may send the DNS request for the advertisement content to the CDN 424. The CDN 424 may then send a request to an advertisement content router 426 for the generated advertisement content, wherein the advertisement content router 426 may return a network path (e.g., URL) for accessing the generated advertisement content. The CDN 424 may use the network path to retrieve the generated advertisement content and send the generated advertisement content to the user device 432.

The user device 432 may then insert the generated advertisement content into the content stream for output at the user device 432. For example, the user device 432 may splice the generated advertisement content into the content stream at a time point associated with the request for a content segment. For example, the content stream may be associated with one or more time points/intervals (e.g., based on a manifest, metadata, etc.) for inserting different generated advertisement content (e.g., one or more content segments) into the content stream. In an example, the computing device 430 may insert/splice the generated advertisement content into the content stream.

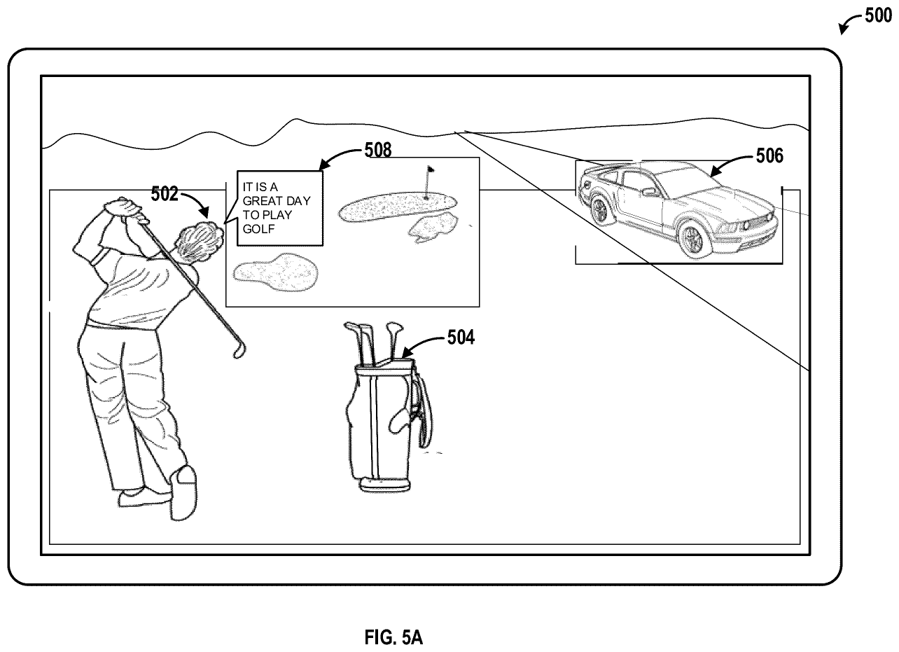

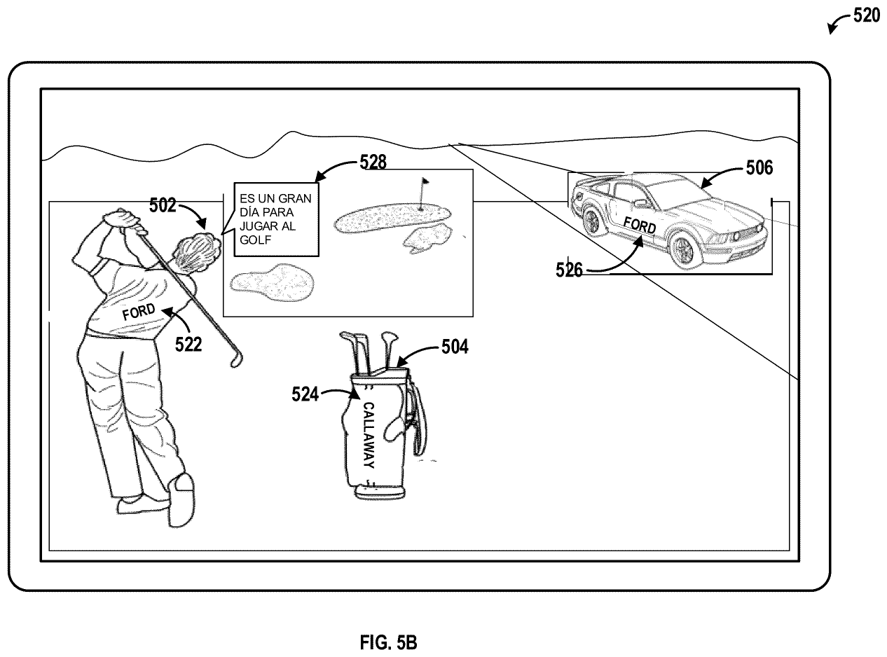

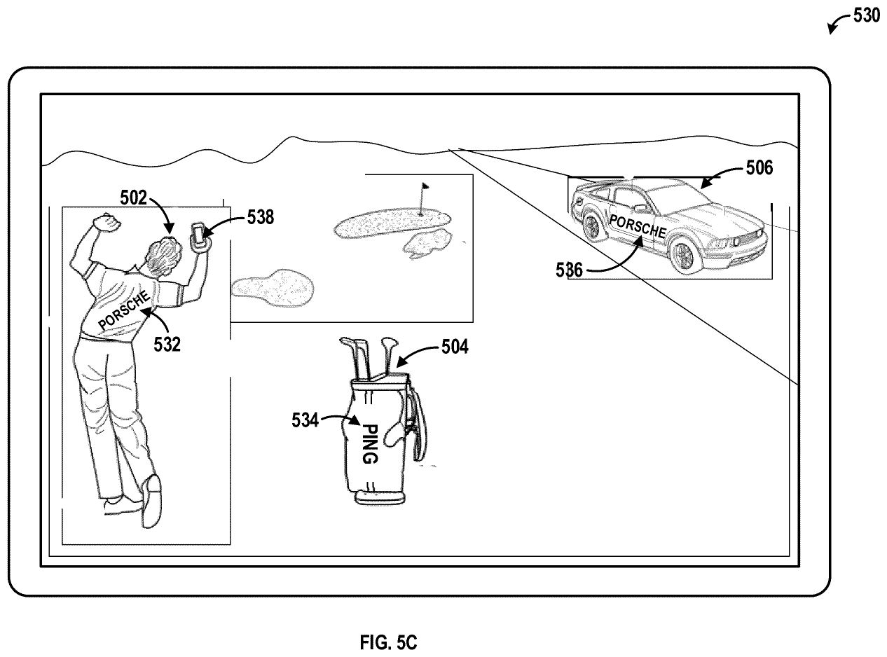

FIGS. 5A-5B show examples 500, 520, 530 of generated content. In an example, as shown in FIG. 5A, a base content segment (e.g., base advertisement content) may comprise content associated with a golf/sports advertisement that may also advertise an automobile (e.g., car, truck, SUV, etc.). For example, the base content segment may display a person 502 playing golf, a golf bag 504, and an automobile 506, and may output audio content 508 (e.g., a voice track of words/language spoken) by one or more individuals in the base content segment. The base content segment may be associated with metadata referring to one or more attributes that may be customizable in the base content segment. For example, any of the person 502, the golf bag 504, the automobile 506, and/or the audio content 508 (e.g., the voice track) may be customizable. A computing device (e.g., computing device 104, a termination system, etc.) may intercept a request for a content segment to be inserted into a content stream being accessed by a user device (e.g., device 102, network device 116, etc.). The computing device may generate a content segment for insertion into the content stream based on user data associated with the user device associated with the request. In one example, based on the user data (e.g., demographic information, personal information, user preference information, language preference information, etc.) associated with the user device, the computing device may determine the user has a preference for Ford products, a preference for Callaway golf products, and a preference for Spanish audio content. As shown in FIG. 5B, the computing device may retrieve the base content segment and include a FORD logo 522 on a shirt worn by the person 502, a CALLAWAY logo 524 on the golf bag 504, and/or a FORD logo 526 on the automobile 506. In addition, the audio content 508 may be replaced with Spanish audio content 528 (e.g., Spanish voice track). For example, a voice track associated with a Spanish translation of the original voice track may replace the original voice track of the base content segment. In another example, the user data may indicate that the user has a preference for Porsche products and Ping golf products and that the user may have a stronger preference for electronics than golf, or sports. As shown in FIG. 5C, the computing device may retrieve the base content segment and include a PORSCHE logo 532 on a shirt worn by the person 502 in addition to showing the person 502 holding an electronic device 538, a PING logo 534 on the golf bag 504, and/or a PORSCHE logo 536 on the automobile 506. As an example, each of the products being advertised may be replaced with the associated brand products. These are examples of many different combinations of methods that may be used to customize each of the attributes of a base content segment. Any combination of methods may be used to customize each of the attributes of a base content segment, for example.

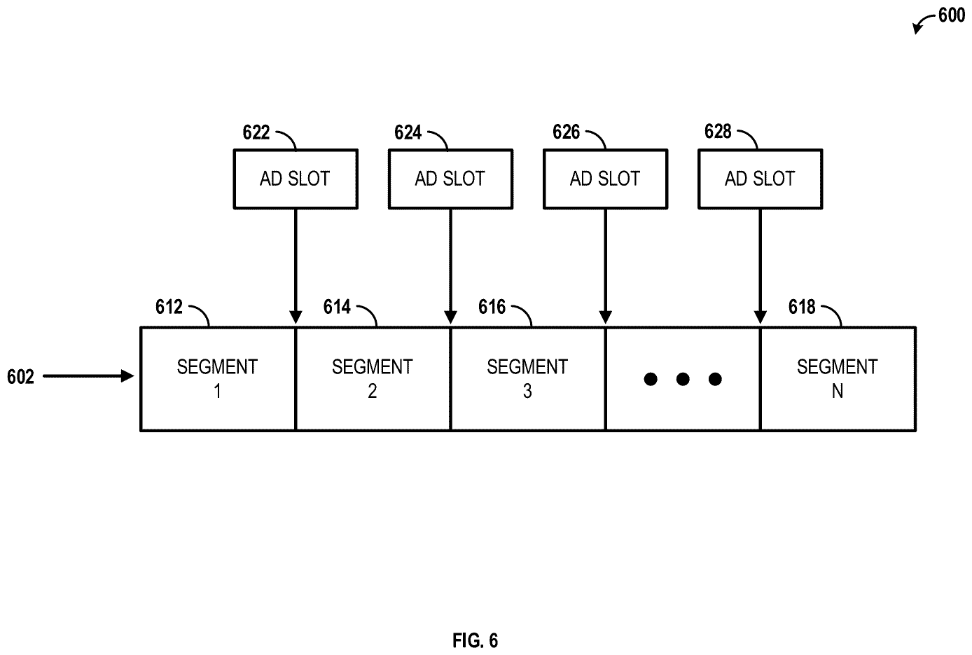

FIG. 6 shows an example advertisement insertion process 600. As an example, a content stream 602 may be associated with data (e.g., metadata, manifests, etc.) for requesting content segments (e.g., advertisement content) for insertion into the content stream 602. Based on the data associated with the content stream 602, a user device (e.g., device 102, network device 116, etc.) may send a request to an initial advertisement server for a content segment (e.g., advertisement content) for insertion into the content stream 602. However, a computing device (e.g., computing device 104, a termination system, etc.) may intercept the request for the content segment and provide a content segment based on the request instead of the initial advertisement server. For example, the content stream 602 may comprise one or more segments 612, 614, 618, 618 associated with one or more advertisement slots 622, 624, 628, 628 (e.g., one or more time points based on the data associated with the content stream) for inserting one or more content segments into the content stream 602, as shown in FIG. 6. The user device may send a request for a content segment at each time point 622, 624, 628, 628 associated with the content stream 602 and receive a content segment based on each request.

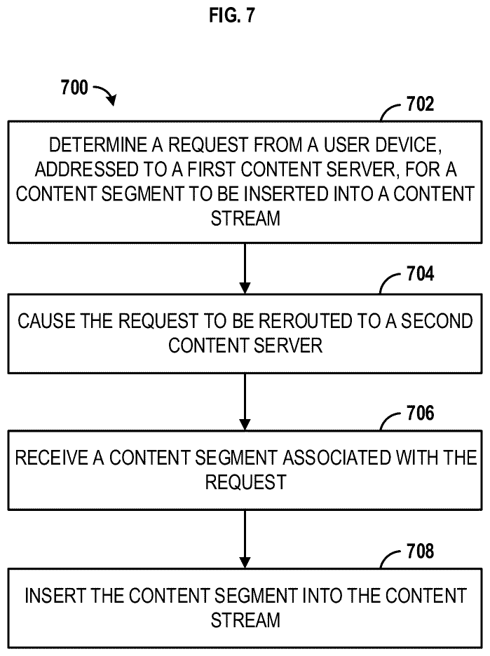

FIG. 7 shows a flowchart of an example method 700 for providing targeted content (e.g., advertisement content). Method 700 may be implemented, for example, by a computing device (e.g., computing device 104, a termination system, etc.). At step 702, a request from a user device, addressed to a first content server, for a content segment to be inserted into a content stream may be determined (e.g., received, intercepted, monitored, captured, and the like) based on the content stream transmitted to the user device. For example, a computing device (e.g., computing device 104, a termination system, etc.) may determine the request from the user device, addressed to the first content server, for a content segment to be inserted into the content stream based on the content stream transmitted to the user device. For example, the computing device may perform a deep packet inspection of data associated with the content stream in order to identify the request for a content segment to be inserted into the content stream. The user device may have initially addressed the request to a first content server. The first content server may comprise a first advertisement server for delivering advertisement content to a user device. In an example, the request may comprise an identifier associated with the user device. In an example, the data associated with the content stream may be determined at one or more time intervals. For example, the content stream may be associated with one or more time points/intervals (e.g., based on a manifest, metadata, etc.) for inserting one or more content segments into the content stream. The user device may send a request for a content segment at each time point associated with the content stream. In an example, the request may comprise a DNS request associated with a URL associated with a manifest for retrieving an advertisement content segment.

At step 704, the request may be rerouted to a second content server. For example, the computing device (e.g., computing device 104, a termination system, etc.) may reroute the request to the second content server. The second content server may comprise a second advertisement server for delivering advertisement content to a user device.

At step 706, a content segment associated with the request may be received from the second content server. For example, the computing device (e.g., computing device 104, a termination system, etc.) may receive the content segment associated with the request from the second content server. In an example, the second content server may determine an identifier associated with the user device. The second content server may determine the content segment based on determining user data associated with the identifier associated with the user device. For example, the second content server may determine the identifier based on the request for a content segment and determine the user data based on the identifier. In an example, the second content server may generate the content segment based on modifying one or more attributes of a base content segment based on the user data associated with the identifier associated with the user device. The user data may comprise one or more of demographic information, personal information, user preference information, or language preference information. In an example, the computing device may determine the identifier based on the request for a content segment and forward the identifier to the second content server in addition to the request for a content segment.

At step 708, the content segment may be inserted into the content stream. For example, the computing device (e.g., computing device 104, a termination system, etc.) may insert the content segment into the content stream. For example, the content segment may be spliced into the content stream at a time point associated with the request for a content segment. For example, a content segment may be inserted/spliced into the content stream at each time point of the one or more time points for inserting one or more content segments into the content stream.

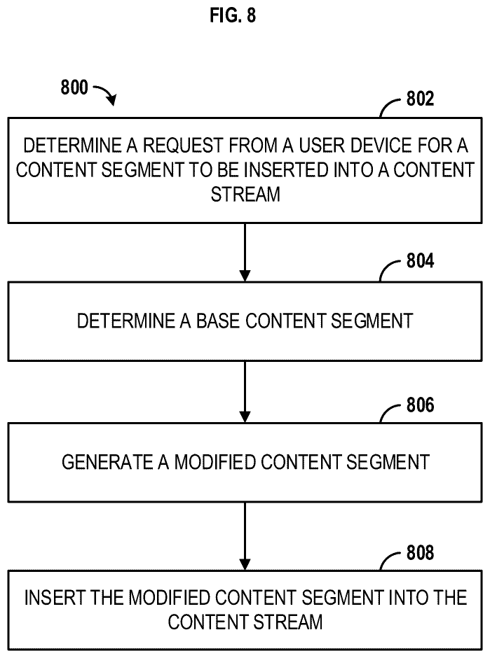

FIG. 8 shows a flowchart of an example method 800 for providing targeted content (e.g., advertisement content). Method 800 may be implemented, for example, by a computing device (e.g., computing device 104, a termination system, etc.). At step 802, a request from a user device for a content segment to be inserted into a content stream may be determined (e.g., received, intercepted, monitored, captured, and the like) based on the content stream transmitted to the user device. For example, a computing device (e.g., computing device 104, a termination system, etc.) may determine the request from the user device for a content segment to be inserted into the content stream based on the content stream transmitted to the user device. For example, the computing device may perform a deep packet inspection of data associated with the content stream in order to identify the request for a content segment to be inserted into the content stream. The user device may have initially addressed the request to a content server. The content server may comprise an advertisement server for delivering advertisement content to a user device. In an example, the request may comprise an identifier associated with the user device. In an example, the data associated with the content stream may be determined at one or more time intervals. For example, the content stream may be associated with one or more time points/intervals (e.g., based on a manifest, metadata, etc.) for inserting one or more content segments into the content stream. The user device may send a request for a content segment at each time point associated with the content stream. In an example, the request may comprise a DNS request associated with a URL associated with a manifest for retrieving an advertisement content segment.

At step 804, a base content segment may be determined based on the content stream. For example, the computing device (e.g., computing device 104, a termination system, etc.) may determine the base content segment based on the content stream. In an example, the base content segment based on the content stream and one or more attributes of the base content segment. The one or more attributes may comprise one or more of an actor, an object, a language, or text. As an example, the base content segment may comprise a generic content segment that may be pre-generated and stored at the computing device. The base content segment may be stored with metadata associated with the base content segment. In an example, the computing device may receive the base content segment and data (e.g., metadata) indicative of the one or more attributes associated with each content segment of the one or more content segments.

At step 806, a modified content segment may be generated based on modifying the one or more attributes associated with the base content segment. For example, the computing device (e.g., computing device 104, a termination system, etc.) may generate the modified content segment based on modifying the one or more attributes associated with the base content segment. In an example, user data associated with the user device may be determined. The one or more attributes associated with the base content segment may be modified based on the user data associated with the user device. As an example, the user data associated with the user device may be determined based on the identifier of the user device. The user data may comprise one or more of demographic information, personal information, user preference information, or language preference information.

At step 808, the modified content segment may be inserted into the content stream. For example, the computing device (e.g., computing device 104, a termination system, etc.) may insert the modified content segment into the content stream. For example, the modified content segment may be spliced into the content stream at a time point associated with the request for a content segment. For example, a content segment may be inserted/spliced into the content stream at each time point of the one or more time points for inserting one or more content segments into the content stream.

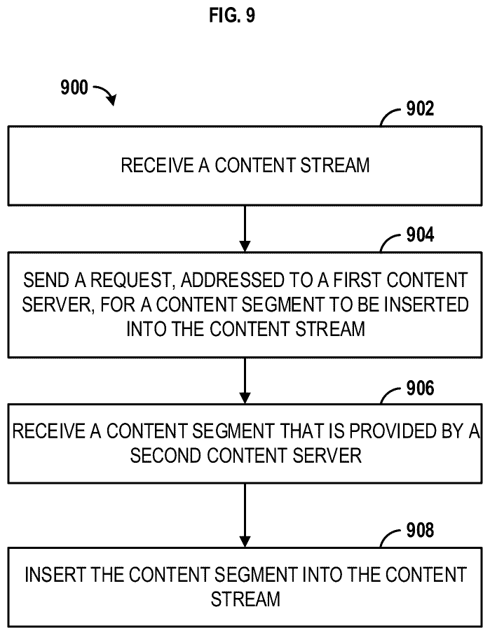

FIG. 9 shows a flowchart of an example method 900 for providing targeted content (e.g., advertisement content). Method 900 may be implemented, for example, by a user device (e.g., user device 102, network device 116, and the like). At step 902, a content stream may be received. For example, a user device (e.g., user device 102, network device 116, and the like) may receive the content stream. For example, the user device may receive the content stream based on a manifest associated with the content stream. In an example, the manifest may be associated with one or more time points/intervals (e.g., based on a manifest, metadata, etc.) for inserting one or more content segments into the content stream. The user device may send a request for a content segment at each time point of one or more time points associated with the content stream based on the manifest.

At step 904, a request, addressed to a first content server, for a content segment to be inserted into the content stream may be sent. For example, the user device (e.g., user device 102, network device 116, and the like) may send the request, addressed to the first content server, for a content segment to be inserted into the content stream. For example, the user device may send the request based on the manifest. The first content server may comprise a first advertisement server for delivering advertisement content to a user device. As an example, the request may comprise an identifier associated with the user device. In an example, the request may comprise a DNS request associated with a URL associated with a manifest for retrieving an advertisement content segment.

At step 906, a content segment that is provided by a second content server may be received based on the request. For example, the user device (e.g., user device 102, network device 116, and the like) may receive the content segment that is provided by the second content server based on the request. In an example, the request may be intercepted and rerouted to the second content server. For example, the request may be intercepted and rerouted to the second content server based on a deep packet inspection of data associated with the content stream. The second content server may comprise a second advertisement server for delivering advertisement content to a user device. In an example, the content segment may be determined, or generated, based user data associated with an identifier of the user device. The user data may comprise one or more of demographic information, personal information, user preference information, or language preference information. As an example, the second content server may generate the content segment based on modifying one or more attributes of a base content segment based on the user data associated with the identifier of the user device. The one or more attributes may comprise one or more of an actor, an object, a language, or text.

At step 908, the content segment may be inserted into the content stream. For example, the user device (e.g., user device 102, network device 116, and the like) may insert the content segment into the content stream. For example, the content segment may be spliced into the content stream at a time point associated with the request for a content segment. For example, a content segment may be inserted/spliced into the content stream at each time point of the one or more time points for inserting one or more content segments into the content stream based on the manifest.

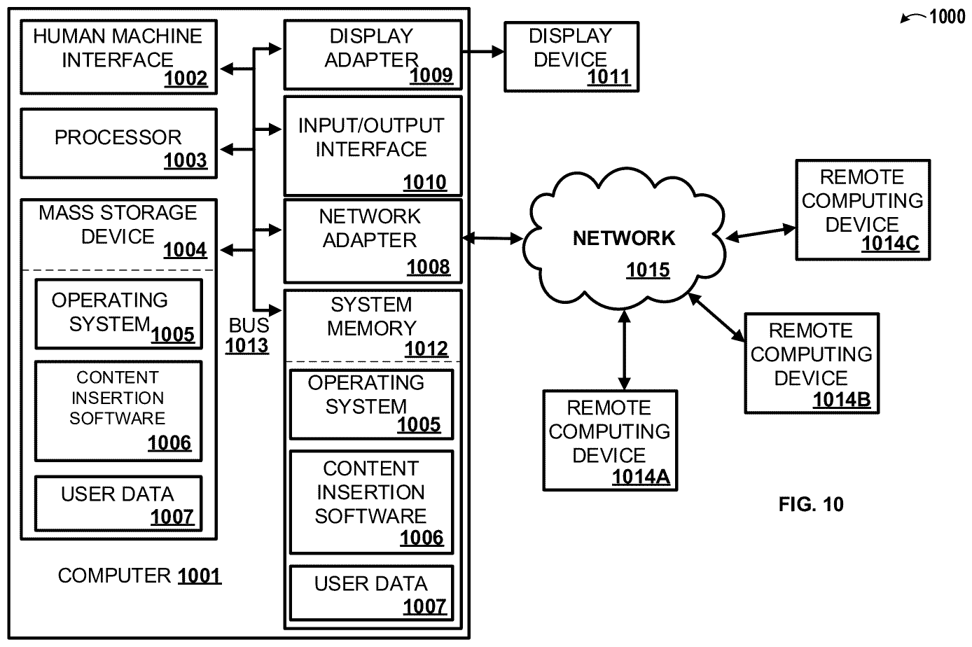

FIG. 10 shows a block diagram illustrating an example computing device. The methods and systems can be implemented on a computer 1001 as shown in FIG. 10 and described below. By way of example, device 102, network device 116, the first advertisement server 140, the second advertisement server 142, and computing device 104 of FIG. 1 can be a computer 1001 as illustrated in FIG. 10. Similarly, the methods and systems disclosed can utilize one or more computers to perform one or more functions in one or more locations. FIG. 10 is a block diagram illustrating an exemplary operating environment 1000 for performing the disclosed methods. This exemplary operating environment 1000 is only an example of an operating environment and is not intended to suggest any limitation as to the scope of use or functionality of operating environment architecture. Neither should the operating environment 1000 be interpreted as having any dependency or requirement relating to any one or combination of components illustrated in the exemplary operating environment 1000.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media including memory storage devices.

Further, one skilled in the art will appreciate that the systems and methods disclosed herein can be implemented via a general-purpose computing device in the form of a computer 1001. The computer 1001 can comprise one or more components, such as one or more processors 1003, a system memory 1012, and a bus 1013 that couples various components of the computer 1001 including the one or more processors 1003 to the system memory 1012. In the case of multiple processors 1003, the system can utilize parallel computing.

The bus 1013 can comprise one or more of several possible types of bus structures, such as a memory bus, memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1013, and all buses specified in this description can also be implemented over a wired or wireless network connection and one or more of the components of the computer 1001, such as the one or more processors 1003, a mass storage device 1004, an operating system 1005, content insertion software 1006, user data 1007, a network adapter 1008, system memory 1012, an Input/Output Interface 1010, a display adapter 1009, a display device 1011, and a human machine interface 1002, can be contained within one or more remote computing devices 1014A-1014C at physically separate locations, connected through buses of this form, in effect implementing a fully distributed system.

The computer 1001 typically comprises a variety of computer readable media. Exemplary readable media can be any available media that is accessible by the computer 1001 and comprises, for example and not meant to be limiting, both volatile and non-volatile media, removable and non-removable media. The system memory 1012 can comprise computer readable media in the form of volatile memory, such as random access memory (RAM), and/or non-volatile memory, such as read only memory (ROM). The system memory 1012 typically can comprise data such as user data 1007 and/or program modules such as operating system 1005 and content insertion software 1006 that are accessible to and/or are operated on by the one or more processors 1003.

The computer 1001 can also comprise other removable/non-removable, volatile/non-volatile computer storage media. By way of example, the computer 1001 can comprise a mass storage device 1004 which can offer non-volatile storage of computer code, computer readable instructions, data structures, program modules, and other data for the computer 1001. For example, a mass storage device 1004 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 704, including by way of example, an operating system 1005 and content insertion software 1006. One or more of the operating system 1005 and content insertion software 1006 (or some combination thereof) can comprise elements of the programming and the content insertion software 1006. User data 1007 can also be stored on the mass storage device 1004. User data 1007 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 1015.

The user can enter commands and information into the computer 1001 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 1003 via a human machine interface 1002 that is coupled to the bus 1013, but can be connected by other interface and bus structures, such as a parallel port, game port, an IEEE 1394 Port (also known as a Firewire port), a serial port, network adapter 1008, and/or a universal serial bus (USB).

A display device 1011 can also be connected to the bus 1013 via an interface, such as a display adapter 1009. It is contemplated that the computer 1001 can have more than one display adapter 1009 and the computer 1001 can have more than one display device 1011. For example, a display device 1011 can be a monitor, an LCD (Liquid Crystal Display), light emitting diode (LED) display, television, smart lens, smart glass, and/or a projector. In addition to the display device 1011, other output peripheral devices can comprise components such as speakers (not shown) and a printer (not shown) which can be connected to the computer 1001 via Input/Output Interface 1010. Any step and/or result of the methods can be output in any form to an output device. Such output can be any form of visual representation, including, but not limited to, textual, graphical, animation, audio, tactile, and the like. The display 1011 and computer 1001 can be part of one device, or separate devices.

The computer 1001 can operate in a networked environment using logical connections to one or more remote computing devices 1014A, 1014B, and 1014C. By way of example, a remote computing device 1014A-1014C can be a personal computer, a computing station (e.g., a workstation), a portable computer (e.g., a laptop, a mobile phone, a tablet device), a smart device (e.g., a smartphone, a smart watch, an activity tracker, a smart apparel, a smart accessory), a security and/or monitoring device, a server, a router, a network computer, a peer device, an edge device or other common network node, and so on. Logical connections between the computer 1001 and a remote computing device 1014A-1014C can be made via a network 1015, such as a local area network (LAN) and/or a general wide area network (WAN). Such network connections can be through a network adapter 1008. A network adapter 1008 can be implemented in both wired and wireless environments. Such networking environments are conventional and commonplace in dwellings, offices, enterprise-wide computer networks, intranets, and the Internet.

For purposes of illustration, application programs and other executable program components such as the operating system 1005 are illustrated herein as discrete blocks, although it is recognized that such programs and components can reside at various times in different storage components of the computer 1001, and are executed by the one or more processors 1003 of the computer 1001. An implementation of content insertion software 1006 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g., a genetic algorithms), swarm intelligence (e.g., an ant algorithms), and hybrid intelligent systems (e.g., expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
determining, by a computing device, based on a content stream transmitted to a user device, a request from the user device, addressed to a first content server, for a content segment to be inserted into the content stream;
causing the request to be rerouted to a second content server;
receiving, from the second content server, a content segment associated with the request; and
inserting the content segment into the content stream.

2. The method of claim 1, wherein the computing device comprises a termination system, wherein the first content server comprises a first advertisement server, and wherein the second content server comprises a second advertisement server.

3. The method of claim 1, wherein the request comprises a DNS request associated with a URL associated with a manifest for retrieving an advertisement content segment.

4. The method of claim 1, wherein determining, based on the content stream transmitted to the user device, the request from the user device, addressed to the first content server, for a content segment to be inserted into the content stream comprises:
determining, based on performing a deep packet inspection of data associated with the content stream, the request from the user device, addressed to the first content server, for a content segment to be inserted into the content stream.

5. The method of claim 4, wherein the data associated with the content stream is determined at one or more time intervals.

6. The method of claim 1, wherein the content segment is determined based on one or more of demographic information, personal information, user preference information, or language preference information.

7. The method of claim 1, wherein the content segment is generated based on modifying one or more attributes of a base content segment based on user data associated with the user device, wherein the one or more attributes comprise one or more of an actor, an object, a language, or text.

8. The method of claim 1, wherein the content segment is spliced into the content stream at a time point associated with the request for a content segment.

9. A method comprising:
determining, by a computing device, based on a content stream transmitted to a user device, a request from the user device for a content segment to be inserted into the content stream;
determining, based on the content stream, a base content segment;
generating, based on modifying one or more attributes of the base content segment, a modified content segment; and
inserting the modified content segment into the content stream.

10. The method of claim 9, further comprising receiving the base content segment and data indicative of the one or more attributes associated with the base content segment.

11. The method of claim 9, wherein the computing device comprises a termination system.

12. The method of claim 9, wherein the request comprises a DNS request associated with a URL associated with a manifest for retrieving an advertisement content segment.

13. The method of claim 9, wherein determining, based on the content stream transmitted to the user device, the request from the user device for a content segment to be inserted into the content stream comprises:
determining, based on performing a deep packet inspection of data associated with the content stream, the request from the user device for a content segment to be inserted into the content stream.

14. The method of claim 9, wherein the one or more attributes comprise one or more of an actor, a language, or text.

15. The method of claim 9, wherein generating, based on modifying the one or more attributes associated with the base content segment, the modified content segment comprises:
determining user data associated with the user device, wherein the user data comprises one or more of demographic information, personal information, user preference information, or language preference information;
modifying, based on the user data associated with the user device, the one or more attributes associated with the base content segment; and
generating, based on modifying the one or more attributes associated with the base content segment, the modified content segment.

16. A method comprising:
receiving, by a user device, a content stream;
sending a request, addressed to a first content server, for a content segment to be inserted into the content stream;
receiving, based on the request, a content segment that is provided by a second content server; and
inserting the content segment into the content stream.

17. The method of claim 16, wherein the first content server comprises a first advertisement server, and wherein the second content server comprises a second advertisement server.

18. The method of claim 16, wherein the request is intercepted and rerouted to the second content server based on a deep packet inspection of data associated with the content stream.

19. The method of claim 16, wherein the content segment is determined based on one or more of demographic information, personal information, user preference information, or language preference information.

20. The method of claim 16, wherein the content segment is generated based on modifying one or more attributes of a base content segment based on user data associated with the user device, wherein the one or more attributes comprise one or more of an actor, an object, a language, or text.
